(19) United States
(12) Patent Application Publication
(10) Pub. No.: US 2025/0026492 A1
(43) Pub. Date: Jan. 23, 2025

(54) AIRCRAFT ASSEMBLY SYSTEM AND ASSEMBLY METHOD USING THE SAME

(71) Applicants: Hyundai Motor Company, Seoul (KR); Kia Corporation, Seoul (KR); Hyundai WIA Corporation, Changwon-si (KR)

(72) Inventors: Dong Ho LEE, Suwon-si (KR); Sang Bin HAN, Hwaseong-si (KR); Myung Kyun JEONG, Hwaseong-si (KR); Chang Hoon LEE, Jeju-si (KR); Tae Hwan KWAK, Yongin-si (KR); Cheol Bae PARK, Changwon-si (KR); Jun Young CHOI, Gimhae-si (KR); Dong Han LEE, Changwon-si (KR); Suk Hyun YOON, Changwon-si (KR); Jeong Rak KIM, Daegu (KR)

(21) Appl. No.: 18/525,345

(22) Filed: Nov. 30, 2023

(30) Foreign Application Priority Data
Jul. 19, 2023 (KR) 10-2023-0093756

(51) Int. Cl. B64F 5/10; G01B 21/22

(52) U.S. Cl. CPC B64F 5/10; G01B 21/22

(57) ABSTRACT

In an assembly system of an aircraft including a fuselage and a wing, the aircraft assembly system may include: a jig unit coupled to the wing to move integrally with the wing; a transfer unit connected to the jig unit and transferring the wing toward the fuselage; a position adjusting unit detachably connected to the jig unit and adjusting a position of the jig unit; and a measuring unit configured for measuring positions of the fuselage and the wing, wherein the fuselage may be relatively fixed to the movement of the wing, wherein the measuring unit may be configured to set a fuselage coordinate system and a wing coordinate system for the fuselage and the wing, respectively, wherein the position adjusting unit may be configured to move the jig unit so that the wing coordinate system coincides with the fuselage coordinate system.

### CROSS-REFERENCE TO RELATED APPLICATION(S)

The present application claims priority to Korean Patent Application No. 10-2023-0093756 filed on Jul. 19, 2023, the entire contents of which is incorporated herein for all purposes by this reference.

### BACKGROUND OF THE PRESENT DISCLOSURE

### Field of the Present Disclosure

The present disclosure relates to an aircraft assembly system and an aircraft assembly method using the same.

### Description of Related Art

An aircraft is manufactured by a combination of a plurality of separately assembled assemblies. Assembling an aircraft may begin with assembling detailed parts to manufacture a unit body of the aircraft. The unit body of an aircraft largely consists of a fuselage and a wing, which may be disposed and assembled adjacent to each other.

For the stability of the aircraft, the wing needs to be accurately assembled in an assembly position of the fuselage. However, because the size of the fuselage and the wing is very large and heavy, it is a complicated and difficult process to accurately align and assemble the wing in the assembly position of the fuselage.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

In general, when assembling a large aircraft, a plurality of supports are provided to align a unit body forming the large aircraft, and there are many variables as the plurality of supports move in respective degrees of freedom.

Various aspects of the present disclosure are directed to providing an aircraft assembly system configured for simplifying a configuration of a system and being accurately aligned and assembled by setting each coordinate system for a fuselage and a wing, and moving the wing coordinate system based on the fuselage coordinate system, and an assembly method using the same.

According to an aspect of the present disclosure, in an assembly system of an aircraft including a fuselage and a wing, the aircraft assembly system may include: a jig unit coupled to the wing to move integrally with the wing; a transfer unit connected to the jig unit and transferring the wing toward the fuselage; a position adjusting unit detachably connected to the jig unit and adjusting a position of the jig unit; and a measuring unit configured for measuring positions of the fuselage and the wing, wherein the fuselage may be relatively fixed to the movement of the wing, wherein the measuring unit may be configured to set a fuselage coordinate system and a wing coordinate system for the fuselage and the wing, respectively, wherein the position adjusting unit may be configured to move the jig unit so that the wing coordinate system coincides with the fuselage coordinate system.

In an exemplary embodiment of the present disclosure, the fuselage may include a plurality of wing coupling units to which the wing is coupled, and the measuring unit may measure a center portion of the plurality of wing coupling units and set the fuselage coordinate system at the center portion of the wing coupling units.

In an exemplary embodiment of the present disclosure, the wing may include a plurality of fuselage coupling units coupled to the plurality of wing coupling units, and the measuring unit may be configured for measuring a center portion of the plurality of fuselage coupling units and set the wing coordinate system at the center portion of the fuselage coupling unit.

In an exemplary embodiment of the present disclosure, the jig unit may include a first jig unit and a second jig unit coupled to first and second sides of the wing, and the first jig unit and the second jig unit may be coupled to each other in a symmetrical position with respect to a center portion of the wing.

In an exemplary embodiment of the present disclosure, the wing may include a first jig coupling unit to which the first jig unit is coupled and a second jig coupling unit to which the second jig unit is coupled, and the first jig coupling unit and the second jig coupling unit may be formed to be symmetrical with respect to a central unit of the wing.

In an exemplary embodiment of the present disclosure, the position adjusting unit may be provided as a pair of position adjusting units to be connected to first and second end portions of the jig unit, respectively, and the pair of position adjusting units may be independently driven, respectively.

In an exemplary embodiment of the present disclosure, the position adjusting unit may include a pair of first position adjusting units connected to the first jig unit and a pair of second position adjusting units connected to the second jig unit.

In an exemplary embodiment of the present disclosure, the jig unit may include a ball stud formed at both end portions, and the position adjusting unit may include a socket to which the ball stud is fastened in a ball joint manner.

In an exemplary embodiment of the present disclosure, the position adjusting unit may include a base, a first sliding unit movably coupled to the base, a second sliding unit movably coupled to the first sliding unit in a second axial direction perpendicular to the first axis, and a rod movably coupled to the second sliding unit in a third axial direction, perpendicular to each of the first axis and the second axis, wherein the third axis may be parallel to a fuselage Z-axis of the fuselage coordinate system.

In an exemplary embodiment of the present disclosure, the wing coordinate system may include a wing X-axis, a wing Y-axis, perpendicular to the wing X-axis, and a wing Z-axis, perpendicular to the wing X-axis and the wing Y-axis, and based on a movement of the jig unit, the wing may perform a linear movement in at least one direction of the wing X-axis, the wing Y-axis, and the wing Z-axis and perform a rotation around at least one direction of the wing X-axis, the wing Y-axis, and the wing Z-axis.

In an exemplary embodiment of the present disclosure, when the wing performs the rotational movement, the jig unit may move along a surface of a sphere including a center point of the wing coordinate system as a center portion and including a distance from the center point of the wing coordinate system to a center portion of the ball stud as a radius.

In an exemplary embodiment of the present disclosure, in an operation in which the wing performs the rotational movement, the position adjusting unit may stop a movement of the jig unit when the ball stud of the jig unit deviates from a path formed on a surface of the sphere.

In an exemplary embodiment of the present disclosure, a control unit may be further included, wherein the control unit may be configured to generate displacement data for a positional difference between the wing coordinate system and the fuselage coordinate system, generate movement path data of the wing for matching the wing coordinate system and the fuselage coordinate system based on the displacement data, and control driving the position adjusting unit based on the movement path data.

According to an aspect of the present disclosure, in an assembly method of an aircraft including a fuselage and a wing, the aircraft assembly method may include: moving and fixing the fuselage to a predetermined position; transferring the wing to an upper portion of the fuselage; fastening a jig unit coupled to the wing to a position adjusting unit; setting a fuselage coordinate system and a wing coordinate system for each of the fuselage and the wing through a measuring unit; primarily aligning the wing based on a positional difference between the fuselage coordinate system and the wing coordinate system, and generating a path for secondary alignment; and secondarily aligning the wing, and assembling the wing and the fuselage, wherein the jig unit may be configured to be moved by the position adjusting unit, and the wing may move together with the jig unit.

In an exemplary embodiment of the present disclosure, when the wing is the primarily aligned, the position adjusting unit may move the jig unit so that the wing moves linearly in a wing X-axis and wing Y-axial directions of the wing coordinate system, and a center point of the wing coordinate system may be located on the same line as a fuselage Z-axis of the fuselage coordinate system.

In an exemplary embodiment of the present disclosure, a path for the secondary alignment may be generated based on an angular difference between the wing coordinate system and the fuselage coordinate system, and may be located on a surface of a sphere including a center point of the wing coordinate system as a center portion and including a distance from the center point of the wing coordinate system to a point at which the jig unit and the position adjusting unit are fastened as a radius.

In an exemplary embodiment of the present disclosure, when the secondary alignment is completed, the wing coordinate system may be aligned to face the same direction as the fuselage coordinate system, but may be spaced from the center point of the fuselage coordinate system with a predetermined distance in a fuselage Z-axial direction thereof.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF DRAWINGS

FIG. 1 illustrates an aircraft assembly system according to an exemplary embodiment of the present disclosure.

FIG. 2 illustrates a position adjusting unit and a jig unit of an aircraft assembly system and an aircraft according to an exemplary embodiment of the present disclosure.

FIG. 3 illustrates a jig unit and a position adjusting unit of an aircraft assembly system according to an exemplary embodiment of the present disclosure.

FIG. 4 illustrates a fuselage and a wing of an aircraft according to an exemplary embodiment of the present disclosure.

FIG. 5 is a partially enlarged view of the fuselage and the wing of the aircraft illustrated in FIG. 4.

FIG. 6A illustrates an operation of adjusting a position of the jig unit and the wing through driving of the position adjusting unit in the aircraft assembly system according to an exemplary embodiment of the present disclosure.

FIG. 6B is a plan view of the wing and the jig unit illustrated in FIG. 6A, as viewed from above.

FIG. 7 is a flowchart of an assembly method of an aircraft by an aircraft assembly system according to an exemplary embodiment of the present disclosure.

It may be understood that the appended drawings are not necessarily to scale, presenting a somewhat simplified representation of various features illustrative of the basic principles of the present disclosure. The predetermined design features of the present disclosure as included herein, including, for example, specific dimensions, orientations, locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, the present disclosure will be described in detail with reference to the accompanying drawings. In adding reference numerals to elements of each of the drawings, although the same elements are illustrated in other drawings, like reference numerals may refer to like elements. Because the present disclosure can make various changes and have various exemplary embodiments of the present disclosure, specific embodiments are illustrated in the drawings and described in detail. However, this is not intended to limit the present disclosure to specific embodiments, and should be understood to include all modifications, equivalents, and substitutes included in the spirit and scope of the present disclosure.

Terms such as “first,” “second,” and the like, may be used to describe various components, but the components should not be limited by the terms. These terms are only used for distinguishing one component from another component. For example, a first element may be termed a second element, and similarly, a second element may be termed a first element, without departing from the scope of the present disclosure. The term ‘and/or’ includes a combination of a plurality of related recited items or any one of a plurality of related recited items.

Terms used in The present application are only used to describe specific embodiments, and are not intended to limit the present disclosure. Singular expressions include plural expressions unless the context thereof is clearly dictated otherwise. In the present application, it should be understood that terms such as “comprise” or “having” do not preclude the presence or addition of one or more other features, numbers, steps, operations, components, parts, or combinations thereof.

Unless defined otherwise, all terms used herein, including technical or scientific terms, include the same meaning as would be commonly understood by one of ordinary skill in the art to which the present disclosure belongs. Terms such as those defined in commonly used dictionaries should be interpreted as having a meaning consistent with the meaning in the context of the related art, and unless explicitly defined in the present application, they should not be interpreted in an ideal or excessively formal sense.

In the present specification, an aircraft may refer to an urban mobility vehicle configured to fly and move through the air. In other words, the aircraft may refer to a rotorcraft, a drone, a tilt rotor aircraft, a vertical take-off and landing aircraft, a fixed-wing aircraft, and the like, and may also include a vehicle which may taxi on the ground or a mooring using landing gear, after the flight. The aircraft may also include a manned aircraft and an unmanned aircraft. The manned aircraft may include a fuselage that can operate by autonomous flight in addition to a fuselage controlled by a pilot.

Hereinafter, various exemplary embodiments of the present disclosure will be described with reference to the drawings.

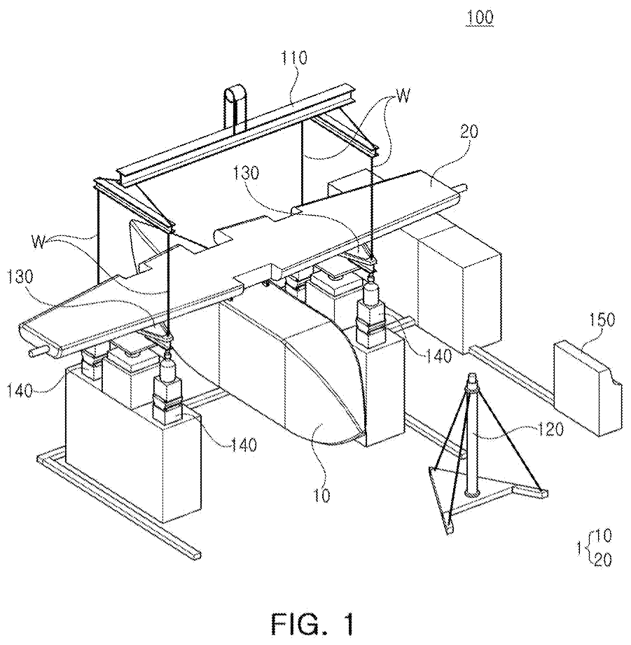

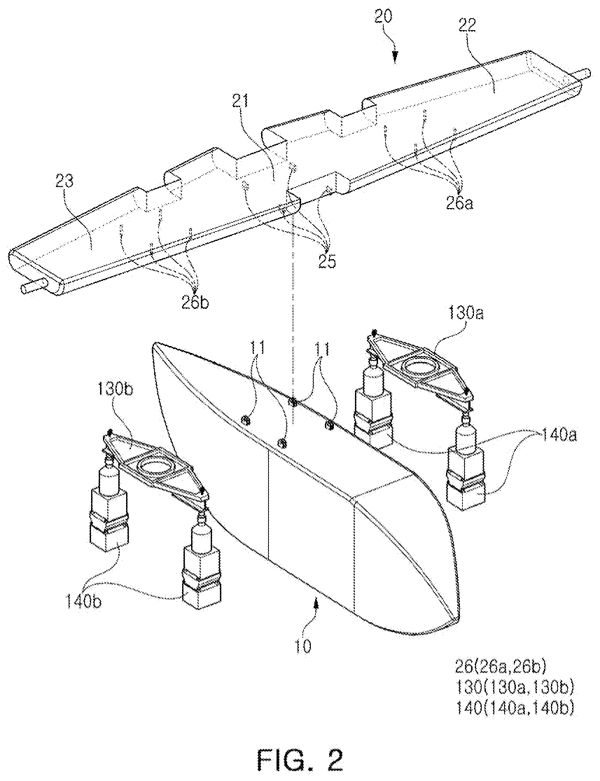

FIG. 1 illustrates an aircraft assembly system 100 according to an exemplary embodiment of the present disclosure. FIG. 2 illustrates a position adjusting unit 140 and a jig unit 130 of an aircraft assembly system 100 and an aircraft 1 according to an exemplary embodiment of the present disclosure.

FIG. 1 schematically illustrates an overall configuration of an aircraft assembly system 100. FIG. 2 is a view in which a transfer unit 110, a measuring unit 120, and a control unit 150 are omitted in the aircraft assembly system 100 of FIG. 1, and illustrates a state in which a wing 20 and a jig unit 130 are separated.

Referring to FIG. 1 and FIG. 2, an aircraft assembly system (or an aircraft assembly facility) 100 according to an exemplary embodiment of the present disclosure is an aircraft 1 is an assembly system or an assembly facility for assembly an aircraft 1 including a fuselage 10 and a wing 20.

For example, the aircraft assembly system 100 may be configured to align the wing 20 to a coupling position on the fuselage 10 through transfer and position adjustment of the wing 20 with respect to the relatively fixed fuselage 10, and then assemble the fuselage 10 and the wing 20. An aircraft 1 according to various exemplary embodiments of the present disclosure may include a fuselage 10 and a wing 20 coupled to the fuselage 10. The aircraft 1 according to the illustrated exemplary embodiment of the present disclosure is a fixed wing aircraft in which the wing 20 is fixed to an upper portion of the fuselage 10, but the aircraft 1 is not limited to the illustrated example, and according to various exemplary embodiments of the present disclosure, the aircraft 1 may include an aircraft to which a fixed wing and a rotation wing are coupled.

The fuselage 10 may include a wing coupling unit 11 to which the wing 20 is coupled. The wing coupling unit 11 may be formed on an upper portion of the fuselage 10. The wing coupling unit 11 may be comprised in plural. For example, the plurality of wing coupling units 11 may be configured using a plurality of clevis, but an exemplary embodiment thereof is not limited thereto.

The wing 20 may include a central unit 21, a right wing unit 22 extending from a right side of the central unit 21, and a left wing unit 23 extending from a left side of the central unit 21. The central unit 21 may be coupled to the fuselage 10, and both wing units 22 and 23 thereof may be coupled to the jig unit 130.

The wing 20 may include a fuselage coupling unit 25 to which the fuselage 10 is coupled. The fuselage coupling portion 25 may be formed in a central unit 21 of the wing 20. For example, the fuselage coupling unit 25 may be formed below the central unit 21 to face the wing coupling unit 11. The fuselage coupling unit 25 may be configured in plural so that the plurality of wing coupling units 11 are coupled. For example, the plurality of fuselage coupling units 25 may be configured using a plurality of lugs, but an exemplary embodiment thereof is not limited thereto. The plurality of fuselage coupling units 25 may be formed in the number and shape corresponding to the plurality of wing coupling units 11, and the wing 20 and the fuselage 10 may be coupled as the plurality of wing coupling units 11 and the plurality of fuselage coupling units 25 are coupled to each other through a pin.

The wing 20 may include a jig coupling unit 26 to which the jig unit 130 is coupled. The jig coupling unit 26 may be formed on both wing units 22 and 23 of the wing 20. For example, the jig coupling unit 26 may include a first jig coupling unit 26a formed on the right wing unit 22 and a second jig coupling unit 26b formed on the left wing unit 23. The first jig coupling unit 26a and the second jig coupling unit 26b may be symmetrical with respect to a central unit 21 of the wing 20. For example, the first jig coupling unit 26a and the second jig coupling unit 26b may be symmetrically formed at a position spaced from the central unit 21 of the wing 20 by the same distance to both sides thereof. The jig unit 130 may be coupled to the jig coupling unit 26 in a process of assembling the wing 20 and the fuselage 10, but when the wing 20 and the fuselage 10 are assembled, the jig unit 130 may be separated.

An aircraft assembly system 100 according to various exemplary embodiments of the present disclosure may include a transfer unit 110, a measuring unit 120, a jig unit 130, a position adjustment unit 140, and a control unit 150.

The transfer unit 110 may transfer the wing 20 to an upper portion of the fuselage 10. For example, the transfer unit 110 may be connected to the jig unit 130 coupled to the wing 20 through a wire W, and may transfer the wing 20 by towing the jig unit 130. Furthermore, the transfer unit 110 may move the jig unit 130 to a position in which it may be connected to the position adjusting unit 140. For example, the transfer unit 110 may move the jig unit 130 to be accommodated or mounted on the position adjustment unit 140. The transfer unit 110 may include a crane, but an exemplary embodiment thereof is not limited thereto.

The measuring unit 120 may measure and track a position of the fuselage 10 and the wing 20. The measuring unit 120 may detect the position of the fuselage 10 and the wing 20 and transmit the detected position signals to the control unit 150. The measuring unit 120 may include a laser tracker, and the laser tracker may irradiate lasers to a plurality of points on the fuselage 10 and the wing 20, to detect positions of the fuselage 10 and the wing 20. The measuring unit 120 may be disposed to face a front of the fuselage 10, but a position of the measuring unit 120 is not limited to the illustrated exemplary embodiment of the present disclosure.

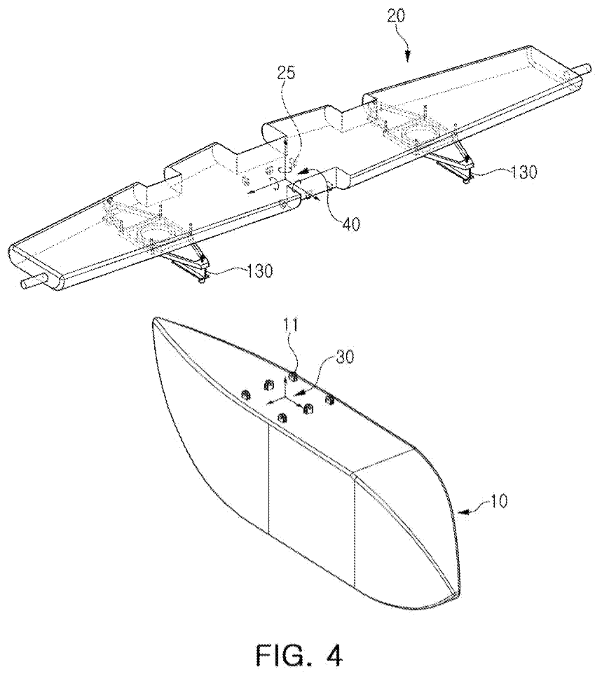

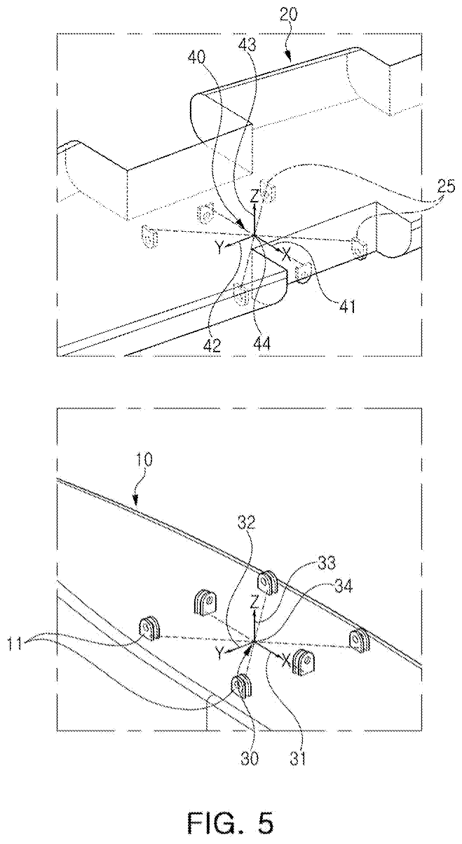

The measuring unit 120 may be configured to generate or set a coordinate system for each of the fuselage 10 and the wing 20. For example, the measuring unit 120 may measure a center portion of the wing coupling unit 11 of the fuselage 10, and generate a coordinate system of the fuselage 10 (e.g., the fuselage coordinate system 30 of FIG. 4 and FIG. 5) at the center portion of the wing coupling unit 11. Furthermore, the measuring unit 120 may measure a center portion of the fuselage coupling unit 25 of the wing 20, and generate a coordinate system of the wing 20 at the center portion of the fuselage coupling unit 25 (e.g., the wing coordinate system 40 of FIG. 4 and FIG. 5). An aircraft assembly system 100 according to an exemplary embodiment of the present disclosure is configured to set respective coordinate systems 30 and 40 to the wing 20 and the fuselage 10 through the measuring unit 120, move the wing 20 using the coordinate system 30 of the fuselage 10 as a fixed coordinate system (or an absolute coordinate system) and align so that the wing 20 and the coordinate systems 30 and 40 of the fuselage 10 coincide with each other to assemble the fuselage 10 and the wing 20.

The jig unit 130 may be coupled to the wing 20 to be movable together with the wing 20. The jig unit 130 may be connected to the transfer unit 110 and the position adjusting unit 140, respectively, and be moved by driving of each of the transfer unit 110 and the position adjusting unit 140. For example, as the wing 20 is connected to the transfer unit 110 and the position adjusting unit 140 via the jig unit 130, the wing 20 may be moved and aligned to an assembly position on the fuselage 10 by operation of moving the jig unit 130. The jig unit 130 may be connected to the transfer unit 110 through a wire W, and may be transferred to an upper portion of the fuselage 10 together with the wing 20 by the transfer unit 110. The jig unit 130 may be transferred to a position in which it may be connected to the position adjusting unit 140 by the transfer unit 110, and may be connected to the position adjusting unit 140 while the wing 20 is located on an upper portion of the fuselage 10. The position of the jig unit 130 may be adjusted so that the fuselage coupling unit 25 of the wing 20 is aligned with the wing coupling unit 11 of the fuselage 10.

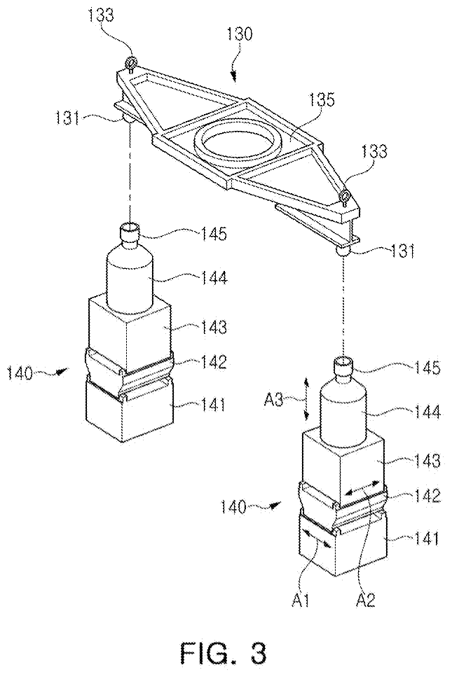

The jig unit 130 may include a first jig unit 130a and a second jig unit 130b coupled to both sides of the wing 20. For example, the first jig unit 130a may be connected to a first jig coupling unit 26a of the right wing unit 22, and the second jig unit 130b may be coupled to a second jig coupling unit 26b of the left wing unit 23. The first jig unit 130a and the second jig unit 130b may include the same shape or structure. A specific shape of the jig unit 130 will be described in detail with reference to FIG. 3 below.

The position adjusting unit 140 may be connected to the jig unit 130, and may adjust a position of the jig unit 130. The position adjusting unit 140 may be provided to be movable in a third axial direction, and may precisely move the jig unit 130 to adjust the position of the jig unit 130. For example, as the position of the jig unit 130 is adjusted by the position adjusting unit 140, the wing 20 may be precisely aligned in the assembly position on the fuselage 10.

The position adjusting unit 140 may support both end portions of the jig unit 130, respectively. For example, the position adjusting unit 140 may include a pair of first position adjusting units 140a connected to both end portions of the first jig unit 130a, and a pair of second position adjusting units 140b connected to both end portions of the second jig unit 130b. Four position adjusting units including the pair of first position adjusting units 140a and the pair of second position adjusting units 140b may be independently driven. The number of position adjusting units 140 is not limited to the illustrated exemplary embodiment of the present disclosure.

The position adjusting unit 140 may be detachably connected to the jig unit 130. For example, when the assembly of the wing 20 and the fuselage 10 is completed, the position adjusting unit 140 and the jig unit 130 may be disconnected or separated. A specific structure of the position adjusting unit 140 will be described in detail with reference to FIG. 3 below.

The control unit 150 may be configured for controlling driving of the transfer unit 110 and the position adjusting unit 140. The control unit 150 may receive a position signal transmitted from the measuring unit 120 and generate displacement data for a positional difference between the fixed coordinate system 30 set for the fuselage 10 and the movement coordinate system 40 set for the wing 20. The control unit 150 may be configured to generate movement path data of the wing 20 for aligning the movement coordinate system to the fixed coordinate system based on the displacement data. The control unit 150 may be configured for controlling driving of the position adjusting unit 140 by generating driving data of the position adjusting unit 140 based on the movement path data and transmitting the data to the position adjusting unit 140.

The aircraft assembly system 100 according to an exemplary embodiment of the present disclosure may be applied to a case in which assembly units are concentrated in a specific area, such as assembly facilities, for a light aircraft.

FIG. 3 illustrates a jig unit 130 and a position adjusting unit 140 of an aircraft assembly system 100 according to an exemplary embodiment of the present disclosure.

FIG. 3 illustrates one jig unit 130 and a pair of position adjusting units 140 supporting the same, but the description below is equally applied to a first jig unit 130a, a second jig unit 130b, a pair of position adjusting units 140a, and a pair of second position adjusting units 140b.

Referring to FIG. 3, the jig unit 130 and the position adjusting unit 140 of the aircraft assembly system 100 according to various exemplary embodiments of the present disclosure may be fastened in a ball joint manner.

The jig unit 130 may be rotatably and detachably coupled to the position adjusting unit 140 using a ball joint structure. The jig unit 130 may include a ball stud 131 fastened to the position adjusting unit 140 in a ball joint manner. The ball stud 131 may be formed at both end portions of the jig unit 130, and may be formed on a lower surface of the jig unit 130 to face the position adjusting unit 140 (e.g., socket 145).

The jig unit 130 may include a wire connection unit 133 to which a wire W of a transfer unit 110 is connected. For example, the wire W may be bound to the wire connection unit 133, and the jig unit 130 may be connected to the transfer unit 110 via the wire W as the wire connection unit 133 and the wire W are bonded. The wire connection unit 133 may be configured using an eyebolt, but an exemplary embodiment thereof is not limited thereto.

The jig unit 130 may include a plate 135 forming a main appearance of the jig unit 130. The wire connection unit 133 may be formed at both end portions of an upper surface of the plate 135, and the ball stud 131 may be formed at both end portions of a lower surface of the plate 135. Here, the upper surface of the plate 135 is a surface to which the wing 20 is coupled, and the lower surface of the plate 135 may face a ground as a surface facing an opposite side of the upper surface.

The position adjusting unit 140 may be configured to move a portion connected to the jig unit 130 in a third axial direction, perpendicular to each other. For example, a portion of the position adjusting unit 140 to which the jig unit 130 is connected may move linearly in three axial directions, perpendicular to each other, respectively (e.g., first axis A1, second axis A2, and third axis A3).

The position adjusting portion 140 may include a base 141, a first sliding unit 142 coupled to the base 141 to be movable (or slidable) in a first axis (A1) direction, a second sliding unit 143 coupled to the first sliding unit 141 to be movable in a second axis (A2) direction, perpendicular to the first axis (A1), and a rod 144 coupled to the second sliding unit 143 to be movable in a third axis (A3) direction, perpendicular to each of the first axis A1 and the second axis A2. The rod 144 may be provided to be drawn into the second sliding unit 143 (e.g., slide-in) or to be drawn out from the inside of the second sliding unit 143 (e.g., slide out) by use of an actuator. Here, the third axis A3 may be parallel to the fuselage Z-axis (e.g., the fuselage Z-axis 33 of FIG. 4 and FIG. 5) of the fuselage coordinate system (e.g., the fuselage coordinate system 30 of FIG. 4 and FIG. 5).

The base 141 may be supported or fixed to a ground. When the first sliding unit 142 moves in the first axis (A1) direction with respect to the base 141 by use of an actuator, the rod 144 and the second sliding unit 143 may move together with the first sliding unit 142. When the second sliding unit 143 moves in the second axis (A2) direction with respect to the first sliding unit 142 by use of an actuator, the base 141 and the first sliding unit 142 may be relatively fixed, and the rod 144 may move together with the second sliding unit 143. When the rod 144 moves in the third axis (A3) direction with respect to the second sliding unit 143, the base 141, the first sliding unit 142, and the second sliding unit 143 may be relatively fixed, and only the rod 144 may move.

The rod 144 may include a socket 145 to which a ball stud 131 of the jig unit 130 is fastened in a ball joint manner. For example, the ball stud 131 and the socket 145 may form a ball joint structure. The socket 145 may be formed at an upper end portion of the rod 144. The socket 145 may be rotatably coupled to the ball stud 131. At least a portion of the ball stud 131 may be accommodated inside the socket 145, and the ball stud 131 may rotate relatively with respect to the socket 145 while being accommodated inside the socket 145. For example, the ball stud 131 may rotate 360 degrees with respect to a center point of the ball stud 131 inside the socket 145. Although not illustrated, a clamp may be provided outside and/or inside the socket 145.

Referring to FIG. 2 together, an aircraft assembly system 100 according to various exemplary embodiments of the present disclosure may include a pair of first position adjusting units 140a and a pair of second position adjusting units 140b, so that four position adjusting units 140 may be independently controlled and driven, respectively. Accordingly, a six degrees of freedom (6DOF) control system configured for linearly moving the wing 20 in three axial directions (e.g., position determination) and rotating around three axes (e.g., orientation determination) may be implemented. The connection between the jig unit 130 and the position adjusting unit 140 is not limited to the ball joint fastening method, and various fastening methods may be applied as long as the wing 20 can move in six degrees of freedom.

FIG. 4 illustrates a fuselage 10 and a wing 20 of an aircraft 1 according to an exemplary embodiment of the present disclosure. FIG. 5 is a partially enlarged view of the fuselage 10 and the wing 20 of the aircraft 1 illustrated in FIG. 4.

FIG. 4 and FIG. 5 are views for illustrating a fuselage coordinate system 30 set in the fuselage 10 and a wing coordinate system 40 set in the wing 20, and FIG. 5 is an enlarged view of a wing coupling unit of the fuselage 10 and a fuselage coupling unit 25 of the wing 20. Hereinafter, FIG. 4 and FIG. 5 are described with reference to FIG. 1, illustrating an overall configuration of the aircraft assembly system 100.

Referring to FIG. 4 and FIG. 5, an aircraft assembly system 100 according to various exemplary embodiments of the present disclosure may set (create) a fuselage coordinate system 30 at a center portion of a wing coupling unit 11 of the fuselage 10 using the measuring unit 120, and set (create) a wing coordinate system 40 in a center portion of a fuselage coupling unit 25 of the wing 20.

In the aircraft assembly system 100, the fuselage 10 may be aligned and fixed in a predetermined position. The measuring unit 120 may set the fuselage coordinate system 30 at the center portion of the wing coupling unit 11 by measuring the center portion of the wing coupling unit 11 of the fixed fuselage 10. For example, because the fuselage 10 maintains a fixed state during an assembly process, the fuselage coordinate system 30 may function as a fixed coordinate system (or an absolute coordinate system). The measuring unit 120 may set the wing coordinate system 40 at the center portion of the fuselage coupling unit 25 by measuring the center portion of the fuselage coupling unit 25 of the wing 20. For example, because the wing 20 moves relative to the relatively fixed fuselage 10 during the assembly process, the wing coordinate system 40 may function as a movement coordinate system which is moved to align with the fuselage coordinate system 30, which is a fuselage coordinate system 30.

The fuselage coordinate system 30 may include a center portion of the plurality of wing coupling units 11 as a center point 34, and may include a fuselage X-axis 31, a fuselage Y-axis 32, and a fuselage Z-axis 33. The fuselage X-axis 31, the fuselage Y-axis 32, and the fuselage Z-axis 33 may be perpendicular to each other. For example, the fuselage coordinate system 30 may be set so that the fuselage Z-axis 33 faces in a vertical direction, perpendicular to a ground, set so that the fuselage X-axis 31 faces in a front and back direction, perpendicular to the fuselage Z-axis 33, and set so that the fuselage Y-axis 32 faces in a left and right direction, perpendicular to both the fuselage X-axis 31 and the fuselage Z-axis 33. However, the direction of the fuselage coordinate system 30 is not limited to the above description.

The wing coordinate system 40 may include a center portion of the plurality of fuselage coupling units 25 as a center point 44, and include a wing X-axis 41, a wing Y-axis 42, and a wing Z-axis 43. The wing X-axis 41, the wing Y-axis 42, and the wing Z-axis 43 may be perpendicular to each other. For example, the wing coordinate system 40 may be set so that the wing X-axis 41 faces the same direction as the fuselage X-axis 31, based on a state in which the wing 20 is assemble to the fuselage 10, set so that the wing Y-axis 42 faces the same direction as the fuselage Y-axis 32, and set so that the wing Z-axis 43 faces the same direction as the fuselage Z-axis 33.

The wing 20 may move in six directions based on the wing coordinate system 40 through an operation of adjusting a position of the jig unit 130 by the position adjusting unit 140. For example, as the first jig unit 130a and the second jig unit 130b move by the four position adjusting units 140, the wing 20 may perform a linear movement or translational movement in the directions of the wing X-axis 41, the wing Y-axis 42, and the wing Z-axis 43, respectively, and perform a rotation around the wing X-axis 41, the wing Y-axis 42, and the wing Z-axis 43, respectively. The rotation of the wing 20 may include rolling in which the wing 20 rotates around the wing X-axis 41, pitching in which the wing 20 rotates around the wing Y-axis 42, and yawing in which the wing 20 rotates around the wing Z-axis 43.

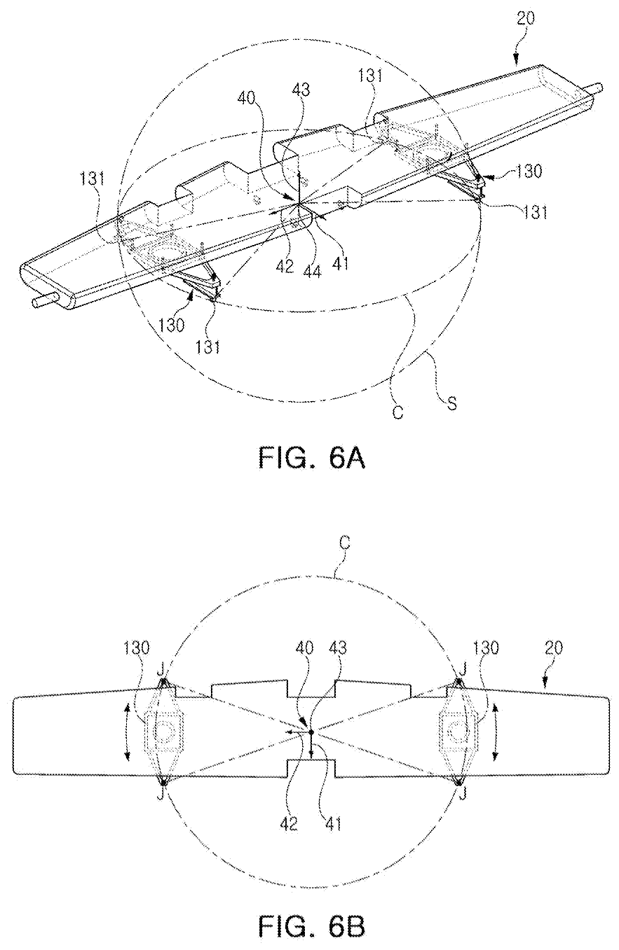

FIG. 6A illustrates an operation of adjusting positions of a jig unit 130 and a wing 20 through driving the position adjusting unit 140 in the aircraft assembly system 100 according to an exemplary embodiment of the present disclosure. FIG. 6B is a plan view of the wing 20 and the jig unit 130 illustrated in FIG. 6A viewed from above.

FIG. 6B schematically illustrates a state in which the wing 20 of FIG. 6A is viewed from above in the direction of the wing Z-axis 43 of the wing coordinate system 50.

FIG. 6A and FIG. 6B illustrate a path through which the jig unit 130 and the wing 20 move through the driving of the position adjusting unit 140, and specifically, illustrates a path through which the wing 20 and the jig unit 130 move, when the wing 20 rotates around the wing X-axis 41, the wing Y-axis 42, and the wing Z-axis 43, respectively. Hereinafter, FIG. 6A and FIG. 6B will be described with reference to FIG. 2, FIG. 3, FIG. 4 and FIG. 5.

Referring to FIG. 6A and FIG. 6B, the position of the wing 20 may be adjusted while moving together with the jig unit 130 based on the movement of the jig unit 130. The jig unit 130 may move by driving the position adjusting unit 140.

The jig unit 130 may include a center point 44 of the wing coordinate system 40 as a center, and may move along an external surface or a surface (e.g., spherical surface) of a sphere(S) including a distance from the center point 44 of the wing coordinate system 40 to a joint point (J) to which the jig unit 130 and the position adjusting unit 140 are fastened in a ball joint manner, as a radius. For example, the radius of the sphere(S) defining a movement path of the jig unit 130 may be a distance from the center point 44 of the wing coordinate system 40 to a center portion (J) of the ball stud 131 formed on the jig unit 130.

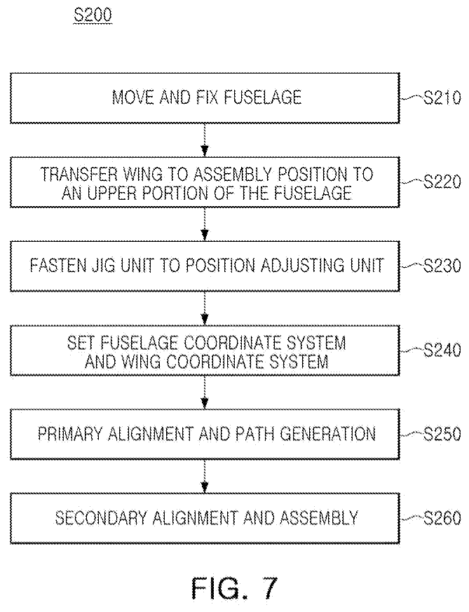

An operation of moving the jig unit 130 illustrated in FIG. 6A and FIG. 6B along the spherical surface may be performed to match the wing coordinate system 40 and the fuselage coordinate system 30 after the wing 20 and the fuselage 10 are aligned in a Z-axial direction (e.g., primary alignment in step S250 in FIG. 7). For example, the aircraft assembly system 100 may be configured to move the wing 20 in the directions of the wing X-axis 41 and the wing Y-axis 42 so that a center point 44 of the wing coordinate system 40 is aligned to be located on the same line as the fuselage Z-axis 33, and then rotate the wing 20 around the wing X-axis 41, the wing Y-axis 42, and the wing Z-axis 43 to be aligned to coincide with the fuselage X-axis 31, the fuselage Y-axis 32, and the fuselage Z-axis 33 of the fuselage coordinate system 30. In the instant case, the jig unit 130 may be moved along a spherical surface by the position adjusting unit 140 to rotate the wing 20 around the wing X-axis 41, the wing Y-axis 42, and the wing Z-axis 43. The control unit 150 may stop the movement of the jig unit 130 and reset a path by controlling the position adjusting unit 140 when the joint point J deviates from a movement path formed on the spherical surface.

With respect to the wing 20 and the jig unit 130 illustrated in FIG. 6A and FIG. 6B, when the wing 20 intends to be rotated (yawing) around the wing Z-axis 43, the jig unit 130 may move along a circle C having a center portion thereof located on the wing Z-axis 43 and passing through four joint points J.

The aircraft assembly system 100 according to various exemplary embodiments of the present disclosure may be configured to generate a movement path of the two jig portions 130 moved by the four position adjusting units 140 on a surface of the sphere S, so that damages to the jig unit 130 fasted to the four adjusting units 140 may be prevented.

FIG. 7 is a flowchart of an aircraft assembly method (S200) by the aircraft assembling system 100 according to an exemplary embodiment of the present disclosure.

FIG. 7 is a flowchart illustrating an assembly method (S200) using the aircraft assembly system 100 described above with reference to FIGS. 1 to 6B, and some steps in FIG. 7 may be performed by components of the aircraft assembly system 100 illustrated in FIGS. 1 to 6B. Hereinafter, FIG. 7 will be described with reference to FIGS. 1 to 6B, and overlapping descriptions will be omitted.

Referring to FIG. 7, the assembly method (S200) of the aircraft assembly system 100 according to various exemplary embodiments of the present disclosure may include moving and fixing a fuselage (S210), transferring a wing to an assembly position above a fuselage (S220), fastening a jig unit to a position adjusting unit (S230), setting a fuselage coordinate system and a wing coordinate system (S240), primarily aligning a wing and generating a path (S250), and secondarily aligning and assembling a wing (S260).

In an operation of moving and fixing a fuselage (S210), the fuselage 10 may be moved to a predetermined position in the aircraft assembly facility 100, aligned with itself, and then fixed.

In an operation of transferring the wing to an assembly position, on an upper portion of the fuselage (S220), the transfer unit 110 may pull the jig unit 130 connected to the wing 20 to transfer the wing 20 to the upper portion of the fuselage 10, which is the assembly position.

In an operation of fastening the jig unit to the position adjusting unit (S230), the transfer unit 110 may transfer the jig unit 130 and be located adjacent to the position adjusting unit 140, and drive the position adjusting unit 140 to seat a ball stud 130 of the jig unit 130 in the socket 145 of the position adjusting unit 140. The ball stud 131 and the socket 145 may be fastened in a ball joint manner.

In an operation of setting the fuselage coordinate system and the wing coordinate system (S240), the measuring unit 120 may set a fuselage coordinate system 30 for the fuselage 10 and a wing coordinate system 40 for the wing 20. However, the operation of setting the fuselage coordinate system and the wing coordinate system (S240) is not necessarily performed after the operation of fastening the jig unit to the position adjusting unit (S230), and may be performed after the operation of transferring the wing to the assembly position on the upper portion of the fuselage (S220). Furthermore, the fuselage coordinate system 30 and the wing coordinate system 40 are not limited to being set in the same operation, and the fuselage coordinate system 30 may be first set after the operation of moving and fixing the fuselage (S210), and the wing coordinate system 40 may be set after the operation of fastening the jig unit to the position adjusting unit (S230).

In an operation of primarily aligning a wing and generating a path (S250), by driving a position adjusting unit 140 to move the jig unit 130 so that a center point 44 of the wing coordinate system 40 is located on the same line as the fuselage Z-axis 33 of the fuselage coordinate system 30, the wing 20 may be primarily aligned. For example, in the case of the primary alignment, the positioning unit 140 may move the jig unit 130 so that the wing 20 linearly moves in the wing X-axis 41 and wing Y-axis 42 directions, and when the primary alignment is completed, the center point 44 of the wing coordinate system 40 is located on a line extending from the fuselage Z-axis.

After the primary alignment of the wing 20 is completed, data on a positional difference between the wing coordinate system 40 and the fuselage coordinate system 30 (, a posture difference) may be generated, and based on the present data, a movement path of the jig unit 130 may be generated. For example, the posture difference between the wing coordinate system 40 and the fuselage coordinate system 30 may mean an angular difference between the wing coordinate system 40 and the fuselage coordinate system 30. Here, the movement path is a movement path of the jig unit 130 for rotating the wing 20 around at least one of the wing X-axis 41, the wing Y-axis 42, and the wing Z-axis 43, such a movement path is defined on an external surface of the sphere S described with reference to FIG. 6A and FIG. 6B. For example, the jig unit 130 may move along the external surface of the sphere S illustrated in FIG. 6A.

In an operation of secondarily aligning and assembling a wing (S250), by adjusting positions of the jig unit 130 and the wing 20 based on the generated path, each of the wing X-axis 41, the wing Y-axis 42, and the wing Z-axis 43 of the wing coordinate system 40 may be aligned to face the same direction as the fuselage X-axis 31, the fuselage Y-axis 32, and the fuselage Z-axis 33. In the instant case, the wing coordinate system 40 and the fuselage coordinate system 30 may be in a state in which other axes are aligned coincidentally except a distance, spaced apart in a Z-axial direction. After checking the state in which the wing coordinate system 40 and the fuselage coordinate system 30 except for the separation distance in the Z-axial direction, the wing 20 may be linearly moved in the wing Z-axis 43 direction so that the center points of the wing coordinate system 40 and the fuselage coordinate system 30 overlap. In the instant case, by subdividing the separation distance in the Z-axial direction, it is possible to check for alignment during transfer by repeating transfer and measurement several times according to the distance. When the wing coordinate system 40 and the fuselage coordinate system 30 are aligned within an allowable tolerance, the fuselage 10 and the wings 20 may be assembled. For example, the fuselage 10 and the wing 20 may be coupled as the fuselage coupling unit 25 and the wing coupling unit 11 are fastened with pins.

As set forth above, according to an exemplary embodiment of the present disclosure, by moving a wing coordinate system based on a fuselage coordinate system, accurate assembly is possible while simplifying an assembly process of the fuselage and the wing.

The aforementioned description merely illustrates the technical concept of the present disclosure, and a person skilled in the art to which an exemplary embodiment of the present disclosure pertains may make various modifications and modifications without departing from the essential characteristics of the present disclosure.

Furthermore, the term related to a control device such as “controller”, “control apparatus”, “control unit”, “control device”, “control module”, or “server”, etc refers to a hardware device including a memory and a processor configured to execute one or more steps interpreted as an algorithm structure. The memory stores algorithm steps, and the processor executes the algorithm steps to perform one or more processes of a method in accordance with various exemplary embodiments of the present disclosure. The control device according to exemplary embodiments of the present disclosure may be implemented through a nonvolatile memory configured to store algorithms for controlling operation of various components of a vehicle or data about software commands for executing the algorithms, and a processor configured to perform operation to be described above using the data stored in the memory. The memory and the processor may be individual chips. Alternatively, the memory and the processor may be integrated in a single chip. The processor may be implemented as one or more processors. The processor may include various logic circuits and operation circuits, may be configured to process data according to a program provided from the memory, and may be configured to generate a control signal according to the processing result.

The control device may be at least one microprocessor operated by a predetermined program which may include a series of commands for carrying out the method included in the aforementioned various exemplary embodiments of the present disclosure.

The aforementioned invention can also be embodied as computer readable codes on a computer readable recording medium. The computer readable recording medium is any data storage device that can store data which may be thereafter read by a computer system and store and execute program instructions which may be thereafter read by a computer system. Examples of the computer readable recording medium include Hard Disk Drive (HDD), solid state disk (SSD), silicon disk drive (SDD), read-only memory (ROM), random-access memory (RAM), CD-ROMs, magnetic tapes, floppy discs, optical data storage devices, etc and implementation as carrier waves (e.g., transmission over the Internet). Examples of the program instruction include machine language code such as those generated by a compiler, as well as high-level language code which may be executed by a computer using an interpreter or the like.

In various exemplary embodiments of the present disclosure, each operation described above may be performed by a control device, and the control device may be configured by a plurality of control devices, or an integrated single control device.

In various exemplary embodiments of the present disclosure, the memory and the processor may be provided as one chip, or provided as separate chips.

In various exemplary embodiments of the present disclosure, the scope of the present disclosure includes software or machine-executable commands (e.g., an operating system, an application, firmware, a program, etc.) for enabling operations according to the methods of various embodiments to be executed on an apparatus or a computer, a non-transitory computer-readable medium including such software or commands stored thereon and executable on the apparatus or the computer.

In various exemplary embodiments of the present disclosure, the control device may be implemented in a form of hardware or software, or may be implemented in a combination of hardware and software.

Furthermore, the terms such as “unit”, “module”, etc. included in the specification mean units for processing at least one function or operation, which may be implemented by hardware, software, or a combination thereof.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In the present specification, unless stated otherwise, a singular expression includes a plural expression unless the context clearly indicates otherwise.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. An aircraft assembly system comprising:
a jig unit coupled to a wing to move integrally with the wing;
a transfer unit connected to the jig unit and transferring the wing toward a fuselage;
a position adjusting unit detachably connected to the jig unit and adjusting a position of the jig unit; and
a measuring unit configured for measuring positions of the fuselage and the wing,
wherein the fuselage is relatively fixed to the movement of the wing,
wherein the measuring unit is further configured to set a fuselage coordinate system and a wing coordinate system for the fuselage and the wing, respectively, and
wherein the position adjusting unit is configured to move the jig unit so that the wing coordinate system coincides with the fuselage coordinate system.

2. The aircraft assembly system of claim 1,
wherein the fuselage includes a plurality of wing coupling units to which the wing is coupled, and
wherein the measuring unit is configured for measuring a center portion of the plurality of wing coupling units and set the fuselage coordinate system at the center portion of the wing coupling units.

3. The aircraft assembly system of claim 2,
wherein the wing includes a plurality of fuselage coupling units coupled to the plurality of wing coupling units, and
wherein the measuring unit is configured for measuring a center portion of the plurality of fuselage coupling units and set the wing coordinate system at the center portion of the fuselage coupling units.

4. The aircraft assembly system of claim 1,
wherein the jig unit includes a first jig unit and a second jig unit coupled to first and second sides of the wing, respectively, and
wherein the first jig unit and the second jig unit are coupled to a symmetrical position of the wing with respect to a center portion of the wing.

5. The aircraft assembly system of claim 4,
wherein the wing includes a first jig coupling unit to which the first jig unit is coupled and a second jig coupling unit to which the second jig unit is coupled, and
wherein the first jig coupling unit and the second jig coupling unit are formed to be symmetrical with respect to a central unit of the wing.

6. The aircraft assembly system of claim 4,
wherein the wing includes a first wing unit on a first side of the wing and a second wing unit on a second side of the wing, and
wherein the central unit connects the first wing unit and the second wing unit.

7. The aircraft assembly system of claim 4, wherein the position adjusting unit is provided as a pair to be connected to first and second end portions of the jig unit, respectively, and the pair of position adjusting units are independently driven, respectively.

8. The aircraft assembly system of claim 7, wherein the pair of the position adjusting units include a pair of first position adjusting units connected to the first jig unit and a pair of second position adjusting units connected to the second jig unit.

9. The aircraft assembly system of claim 1,
wherein the jig unit includes a ball stud formed at first and second end portions of the jig unit, and
wherein the position adjusting unit includes a socket to which the ball stud is fastened in a ball joint manner.

10. The aircraft assembly system of claim 9,
wherein the position adjusting unit includes a base, a first sliding unit movably coupled to the base in a first axial direction, a second sliding unit movably coupled to the first sliding unit in a second axial direction perpendicular to the first axis, and a rod movably coupled to the second sliding unit in a third axial direction perpendicular to each of the first axis and the second axis, and
wherein the third axis is parallel to a fuselage Z-axis of the fuselage coordinate system.

11. The aircraft assembly system of claim 9,
wherein the wing coordinate system includes a wing X-axis, a wing Y-axis, perpendicular to the wing X-axis, and a wing Z-axis, perpendicular to the wing X-axis and the Y-axis, and
wherein, in response to the movement of the jig unit, the wing linearly moves in at least one direction of the wing X-axis, the wing Y-axis, and the wing Z-axis, and rotates around at least one direction of the wing X-axis, the wing Y-axis, and the wing Z-axis.

12. The aircraft assembly system of claim 11,
wherein for the rotation of the wing, the jig unit moves along a surface of a sphere including a center point of the wing coordinate system as a center portion of the sphere and a distance from the center point of the wing coordinate system to a center portion of the ball stud as a radius of the sphere.

13. The aircraft assembly system of claim 12, wherein in rotating the wing, when the ball stud of the jig unit deviates from a path formed on the surface of the sphere, the position adjusting unit is configured to stop the movement of the jig unit.

14. The aircraft assembly system of claim 13, further including:
a control unit operatively connected to the position adjusting unit and the measurement unit,
wherein the control unit is configured to:
generate displacement data for a positional difference between the wing coordinate system and the fuselage coordinate system;
generate movement path data of the wing for matching the wing coordinate system and the fuselage coordinate system based on the displacement data, and
control driving of the position adjusting unit, based on the movement path data.

15. The aircraft assembly of claim 11, wherein the wing coordinate system is aligned to face a same direction as the fuselage coordinate system, but is spaced from a center point of the fuselage coordinate system with a predetermined distance in a fuselage Z-axis direction.

16. An aircraft assembly method comprising operations of:
moving and fixing a fuselage to a predetermined position;
transferring a wing to an upper portion of the fuselage;
fastening a jig unit coupled to the wing to a position adjusting unit;
setting, by a control unit, a fuselage coordinate system and a wing coordinate system for each of the fuselage and the wing through a measuring unit operatively connected to the control unit;
primarily aligning, by the control unit operatively connected to the position adjusting unit, the wing based on a positional difference between the fuselage coordinate system and the wing coordinate system, by controlling the position adjusting unit, and generating, by the control unit, a path for secondary alignment; and
performing the secondary alignment of the wing, and assembling the wing and the fuselage,
wherein the jig unit is configured to be moved by the position adjusting unit, and the wing move together with the jig unit.

17. The aircraft assembly method of claim 16, wherein in the primarily aligning,
the control unit is configured to control the position adjusting unit to move the jig unit so that the wing moves linearly in wing X-axis and wing Y-axis directions of the wing coordinate system, and
a center point of the wing coordinate system is located on a same line as a fuselage Z-axis of the fuselage coordinate system.

18. The aircraft assembly method of claim 17,
wherein a path for the secondary alignment is generated by the control unit based on an angular difference between the wing coordinate system and the fuselage coordinate system, and
wherein the path is located on a surface of a sphere including a center point of the wing coordinate system as a center portion of the sphere and a radius of a distance from the center point of the wing coordinate system to a point to which the jig unit and the position adjusting unit are fastened as a radius of the sphere.

19. The aircraft assembly method of claim 18, wherein when the secondary alignment is completed,
the wing coordinate system is aligned to face a same direction as the fuselage coordinate system, but is spaced from a center point of the fuselage coordinate system with a predetermined distance in a fuselage Z-axis direction.
